(19) United States
(12) Patent Application Publication
(10) Pub. No.: US 2009/0164590 A1
(43) Pub. Date: Jun. 25, 2009

(54) APPARATUS AND METHOD FOR PROVIDING REAL-TIME EVENT UPDATES

(75) Inventor: Richard L. GARCIA, Fremont, CA (US)

Correspondence Address: COOLEY GODWARD KRONISH LLP;ATTN: Patent Group, Suite 1100, 777 - 6th Street, NW, Washington, DC, 20001, US

(73) Assignee: G-SNAP!, INC., Pleasanton, CA (US)

(21) Appl. No.: 12/027,955

(22) Filed: Feb. 7, 2008

Related U.S. Application Data
(60) Provisional application No. 61/015,379, filed on Dec. 20, 2007.

(51) Int. Cl. G06F 15/16

(52) U.S. Cl. 709/206

(57) ABSTRACT

A computer readable storage medium includes executable instructions to collect information from a community of event updaters regarding an ongoing event. The information is sent to a recipient community of users that has requested ongoing event updates.

### CROSS-REFERENCE TO RELATED APPLICATION

This application claims priority to U.S. Provisional Patent Application Ser. No. 61/015,379, filed Dec. 20, 2007, entitled “Apparatus and Method for Providing Real-Time Event Updates”, the contents of which are incorporated herein by reference.

### FIELD OF THE INVENTION

This invention relates generally to networked communications. More particularly, this invention relates to techniques for providing real-time event updates across a network.

### BACKGROUND OF THE INVENTION

Individuals are able to observe many mass appeal events (e.g., professional sporting events, conferences, lectures) via attendance or broadcasts of those events. Unfortunately, when observing those events, individuals are commonly removed from friends who are also observing the same events. It would be desirable to provide new techniques to allow physically displaced individuals to share and/or complement the experience of mass appeal events that are attended or broadcasted.

Individuals are frequently precluded from observing niche appeal events (e.g., a youth basketball game). Nevertheless, there is often a great interest in following the action associated with such an event. It would be desirable to provide new techniques to allow individuals to follow niche appeal events.

### SUMMARY OF THE INVENTION

A computer readable storage medium includes executable instructions to collect information from a community of event updaters regarding an ongoing event. The information is sent to a recipient community of users that has requested ongoing event updates.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates event update processing operations associated with an embodiment of the invention.

FIG. 3 illustrates a Graphical User Interface (GUI) configured in accordance with an embodiment of the invention.

FIG. 4 illustrates a GUI for a mobile device utilized in accordance with an embodiment of the invention.

FIG. 5 illustrates a commentary input GUI that may be utilized in accordance with an embodiment of the invention.

FIG. 6 illustrates a commentary input GUI that may be utilized with a mobile device in accordance with an embodiment of the invention.

FIG. 7 illustrates polling operations associated with an embodiment of the invention.

FIG. 8 illustrates poll solicitation techniques utilized in accordance with an embodiment of the invention.

FIG. 9 illustrates a poll GUI for a mobile device utilized in accordance with an embodiment of the invention.

FIG. 10 illustrates processing to support multiple event updates in accordance with an embodiment of the invention.

FIG. 11 illustrates a mobile device displaying multiple event updates in accordance with an embodiment of the invention.

FIG. 12 illustrates shorthand event update techniques utilized in accordance with an embodiment of the invention.

FIG. 13 illustrates a multiple event update technique utilized in accordance with another embodiment of the invention.

FIG. 14 illustrates event notification processing in accordance with an embodiment of the invention.

FIG. 15 illustrates centralized event rating processing in accordance with an embodiment of the invention.

FIG. 16 illustrates an event rating GUI that may be utilized in accordance with an embodiment of the invention.

FIG. 17 illustrates event updating dating techniques that utilize a cache breaking link in accordance with an embodiment of the invention.

FIG. 18 illustrates an event update panel incorporated into a larger GUI in accordance with an embodiment of the invention.

FIG. 19 illustrates event update processing utilized in accordance with an embodiment of the invention.

FIG. 20 illustrates a mobile device in a dark mode invoked in accordance with an embodiment of the invention.

FIG. 21 illustrates a mobile device GUI used to submit comments to an individual providing event updates.

FIG. 22 illustrates a GUI to process comments received from event viewers.

FIG. 23 illustrates a mobile device with different content regions in accordance with an embodiment of the invention.

Like reference numerals refer to corresponding parts throughout the several views of the drawings.

### DETAILED DESCRIPTION OF THE INVENTION

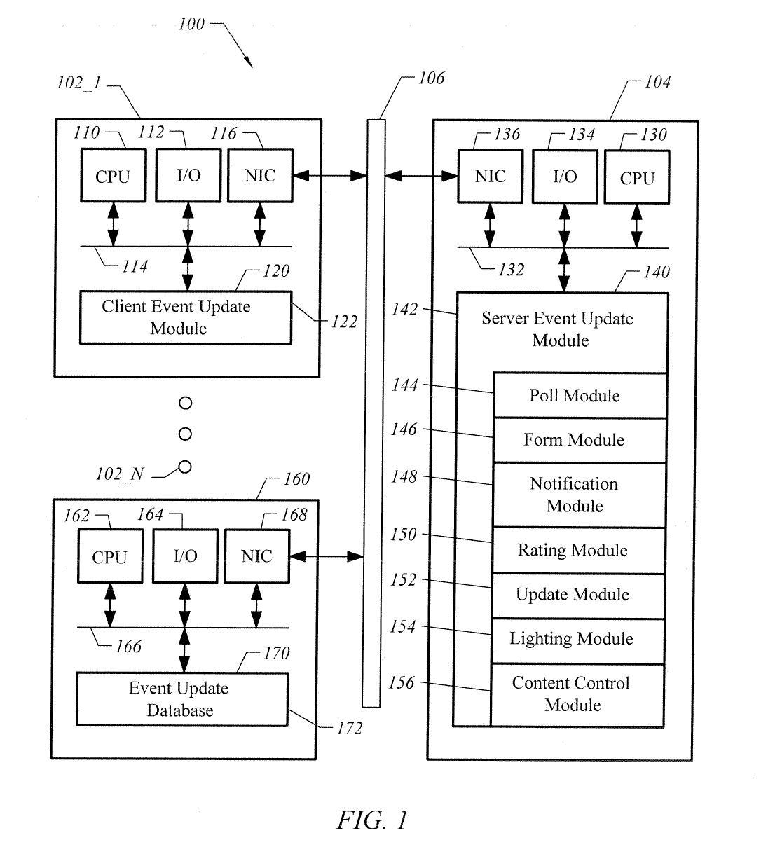

FIG. 1 illustrates a system 100 configured in accordance with an embodiment of the invention. The system 100 includes a set of client devices 102_1 through 102_N and at least one server 104. Each client device 102 may be in a variety of configurations, such as a personal computer, mobile telephone, personal digital assistant, and the like. The clients 102 and server 104 are connected via a communication infrastructure 106, which may be any wired or wireless communication system.

Each client device 102 includes standard components, such as a central processing unit (110) and input/output devices 112 linked via a bus 114. The input/output devices 112 may include a keyboard, touchpad, display, and the like. A network interface card (NIC) 116 is also connected to the bus 114. The NIC 116 provides wired or wireless access to the server 104. A memory 120 is also connected to the bus 114. The memory 120 stores a client event update module 122. The client event update module 122 includes executable instructions to support operations of the invention, as discussed below.

The server 104 also includes standard components, such as a CPU 130 connected to input/output devices 134 via a bus 132. A NIC 136 is also connected to the bus 132. A memory 140 is also connected to the bus 132. The memory 140 stores a server event update module 142, which includes executable instructions to support operations of the invention, as discussed below. In one embodiment, the server event update module 142 includes a poll module 144 to support polling operations that solicit votes from users regarding an event. A form module 146 includes executable instructions to supply and process forms that are used to facilitate event updates. A notification module 148 includes executable instructions to alert users of an event update session. A rating module 150 includes executable instructions to solicit, process and distribute event rating information. An update module 152 includes executable instructions to refresh event information. A lighting module 154 includes executable instructions to control the lighting characteristics of displays associated with client devices. Finally, a content control module 156 includes executable instructions to control access to and the display of selective content.

The system 100 may also include one or more additional machines 160. In this example, machine 160 includes standard components, such as a CPU 162 and Input/Output devices 164 connected via bus 166. A NIC 168 is also connected to the bus 166. A memory 170 is also connected to the bus 166. The memory 170 stores an event update database to store event information, as discussed below.

The system 100 is exemplary. For example, the modules associated with the server event update module 142 may be combined or further sub-divided. The operations associated with the server event update module 142 need not reside on a single machine; that is, they may be distributed across a network. For example, some of the modules may reside on machine 160, while the event update database 172 may reside on machine 104. It is the operations of the invention that are significant, not the precise location or manner in which they are implemented.

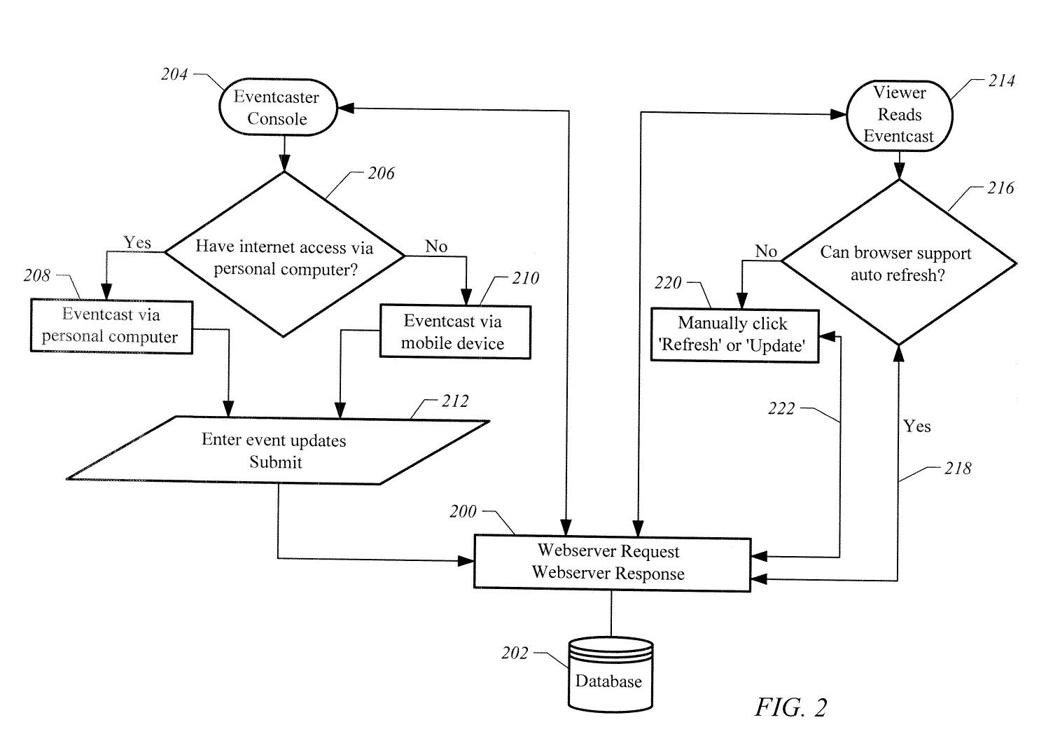

The operation of system 100 is more fully appreciated in connection with the following figures. FIG. 2 illustrates processing operations to support real-time event updates to a large audience in accordance with an embodiment of the invention. A web server request/response block 200 services event update requests and supplies responses. This operation may be facilitated with access to a database 202. The database 202 may correspond to database 160 of FIG. 1 and the web server request/response block 200 may correspond to sever 104 of FIG. 1.

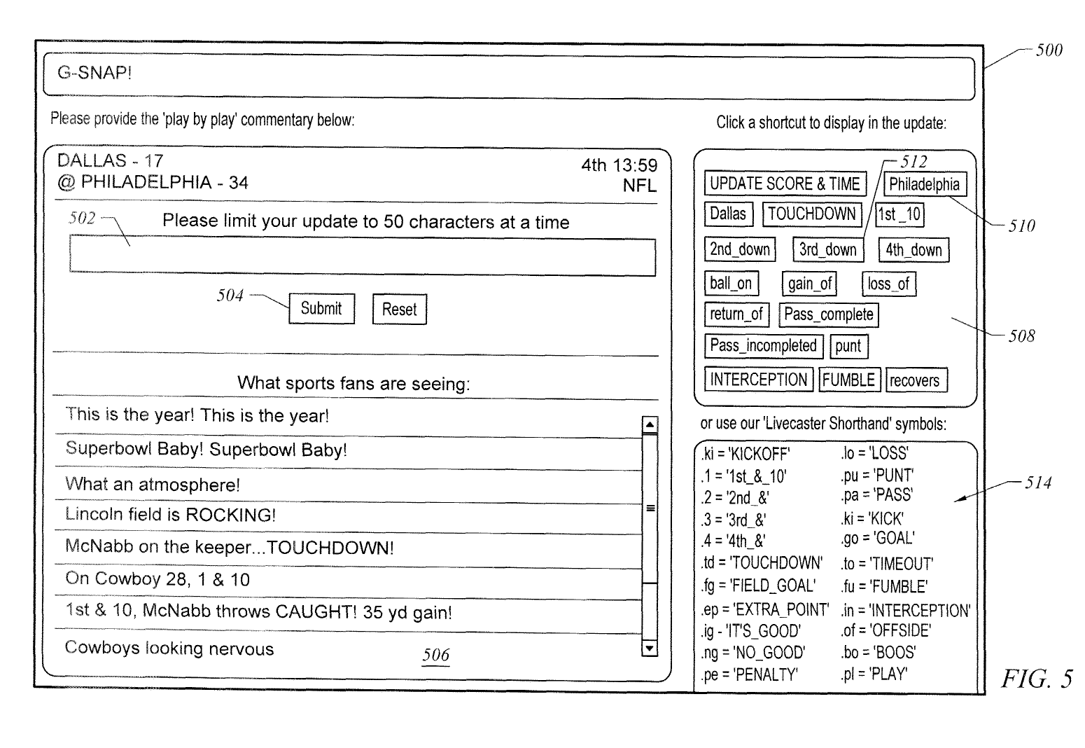

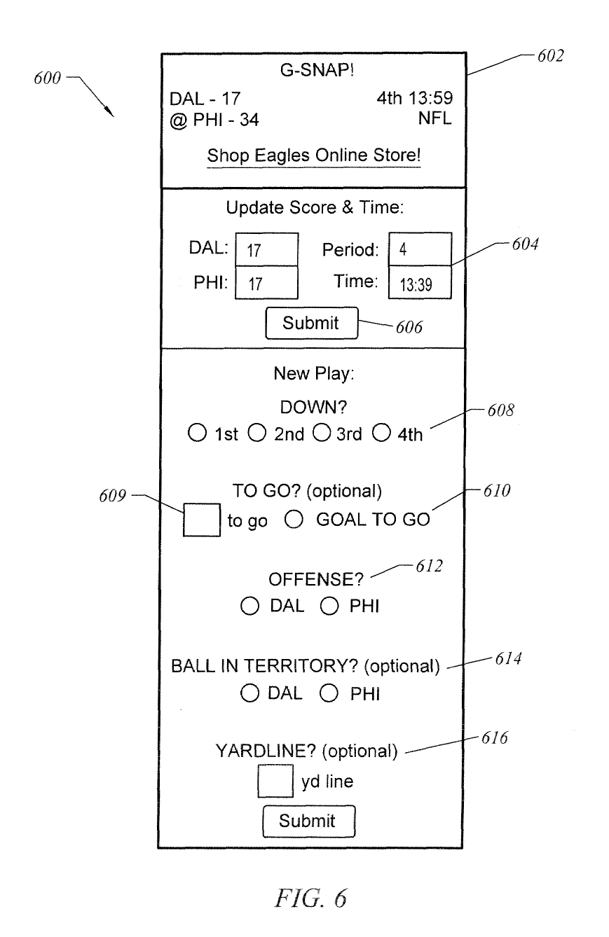

An input device (e.g., the GUI 500 of FIG. 5 or the GUI 600 of FIG. 6) may operate as an event cast console 204. At block 206 it is determined whether Internet access is via a mobile connection or a wire-based connection. If access is via a wire-based connection (e.g., Local Area Network (LAN), Digital Subscriber Line (DSL), Cable, etc.), event information is broadcast to the Internet via a hardwired computer device 208. Otherwise, event information is broadcast to the Internet via a mobile (i.e., wireless) device 210. Event updates are entered and then submitted 212. The web server request/response block 200 then services the request. For example, a viewer reads the event information 214. This may be done at one or more client devices 102. If the browser supports automatic refresh, as determined at block 216, then the web server request/response block supplies the information via automatic refresh. Otherwise, the user manually clicks for a refresh or update of event information 220.

An individual event broadcaster (or a community of event broadcasters) submits short text update messages characterizing an event. Each event is assigned a specific identifier. Updates may be supplied via a web form or mobile browser. The invention supports characterization of any event, including sport events, concerts, conferences, reunions, health events, and public emergency information. The submitted data is written to a database (e.g., 172). This data is then served with its associated event identifier. The data can be presented in various ways, such as a web page, mobile web page, Short Message Service (SMS) text, Instant Message (IM), and the like.

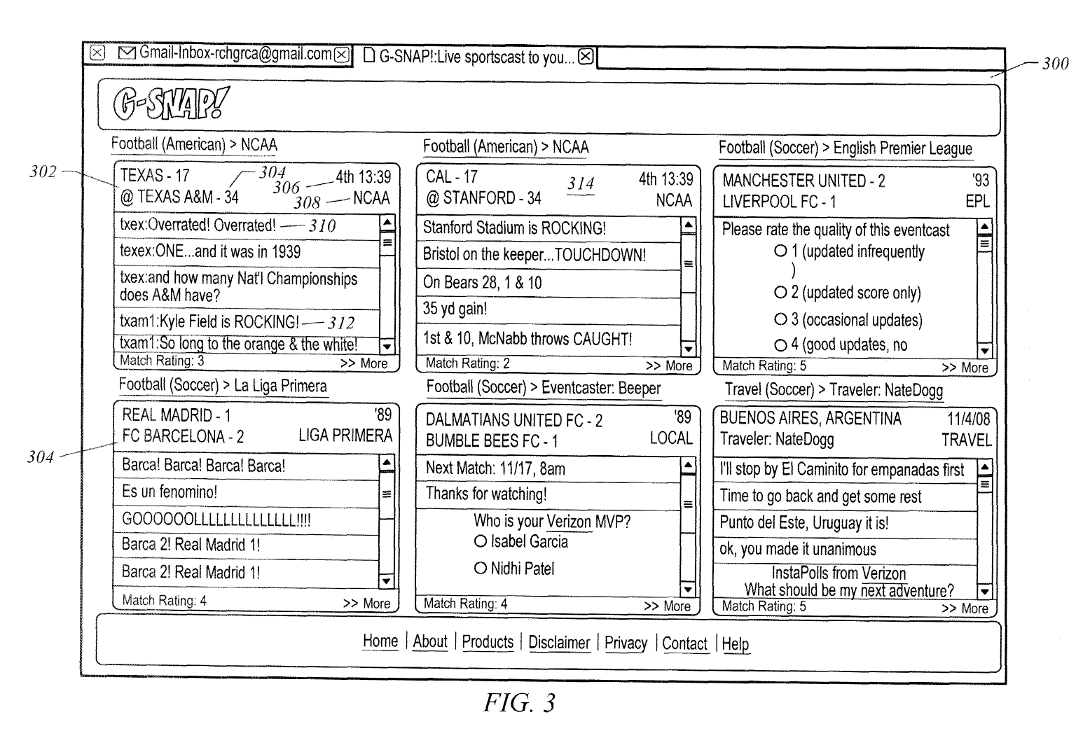

FIG. 3 illustrates a GUI 300 for display of event updates in accordance with an embodiment of the invention. The events displayed in GUI 300 include American football events and soccer events. For example, panel 302 displays event update information on an American football game between college football teams Texas and Texas A&M. The panel 302 includes a score 304, the period of the game 306 and the time remaining in the period 308. The panel 302 also includes commentary from updaters “txex” 310 and “txam” 312. Panel 314 includes information on a different game with input from a single event updater. Thus, an individual looking at GUI 300 can follow multiple sporting events. In addition, the user can have a communal experience by following the commentary supplied by a community of users. Thus, a widely followed broadcast event may be personalized through interactions associated with the invention. An individual may also follow non-broadcasted events, such as a soccer game transpiring in Europe, by following updates provided by one or more event updaters, as shown in panel 304 of FIG. 3. In this way, an individual gains access to events that are otherwise inaccessible.

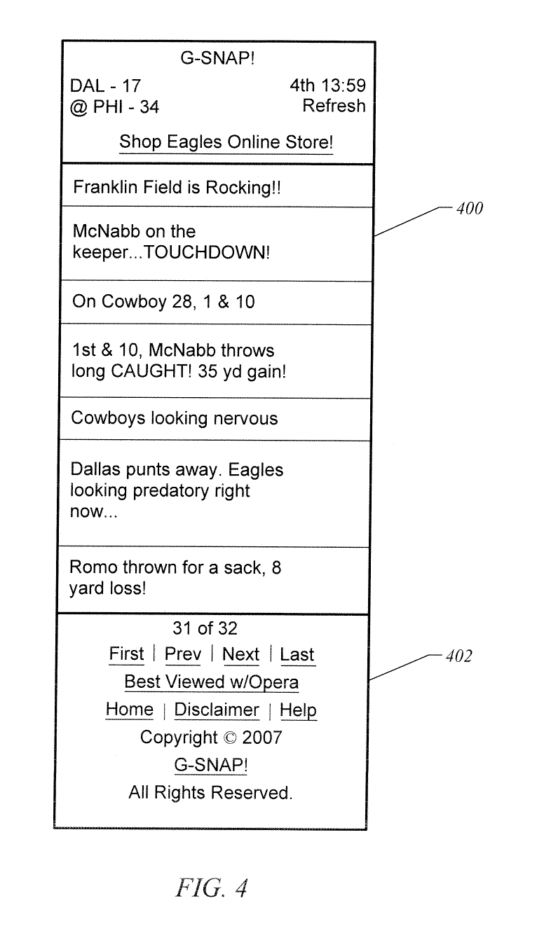

FIG. 4 illustrates a GUI 400 for display of event updates on a mobile device. In this example, the updates relate to a National Football League (NFL) game between the Dallas Cowboys and Philadelphia Eagles. The GUI 400 includes controls 402 to view different screens, such as the first, previous, next and last screens. Observe that this GUI 400 allows one to inconspicuously receive event information. This stands in contrast to, for example, receiving telephone calls with the same information.

FIG. 5 illustrates a GUI 500 to secure information regarding an event. The GUI 500 includes a text entry block 502 to allow a user to key in information about an event, in this case an NFL game between the Cowboys and Eagles. Once the information is entered, it may be submitted with button 504. Block 506 displays the information that has been updated for recipients. Block 508 includes buttons to instantly enter text. For example, by clicking on buttons 510 and 512, the text “Philadelphia Touchdown” will appear. Block 514 displays keystroke shortcuts that may be used to enter information. In this example, typing “.fg .ng” will produce “FIELD GOAL NO GOOD” in the text box.

FIG. 6 illustrates a GUI 600 for receiving information regarding an event on a mobile device. Section 602 displays event information. Section 604 allows a user to specify score, period, and time information, which may be submitted with the submit button 606. The down may be specified by selecting a radio button 608. The distance to a first down may be specified in block 609 or with radio button 610. The team on offense may be specified with radio button 612. The territory of the ball may be specified with radio buttons 614. The yard line may be specified with block 616.

An embodiment of the invention allows the generation of a customizable poll to be taken by viewers. These operations may be supported by the poll module 144. Poll results may be selected via a web page or a mobile web page. In this embodiment, a poll or survey is broadcasted. Viewers reply to the poll by sending responses back to a server, which manipulates and presents the results. The results may be in the form of raw or tailored data. The results may be presented textually or graphically.

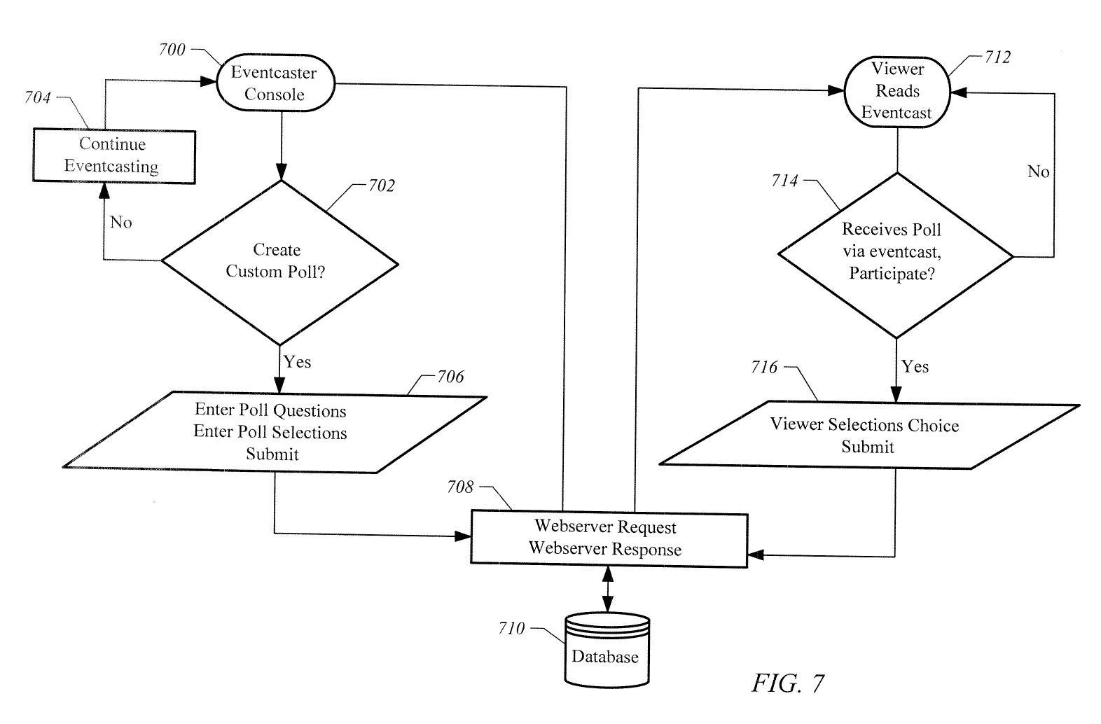

FIG. 7 illustrates processing operations associated with this embodiment of the invention. From a client event console 700, a user is queried whether to create a custom poll 702. If the user answers no, event updates are continued in a normal mode 704. If the user answers yes, the user is supplied with a form to enter poll questions, which are then submitted 706. The poll questions are submitted to the server, which provides requests and responses 708. Meanwhile, a viewer is following an event 712. If a user receives a poll request (714—YES), the viewer may specify poll choices and submit the choices 716. The web server processes the choices and selectively stores them in database 710. If a user decides not to participate in the poll (714—NO), the event updates continue.

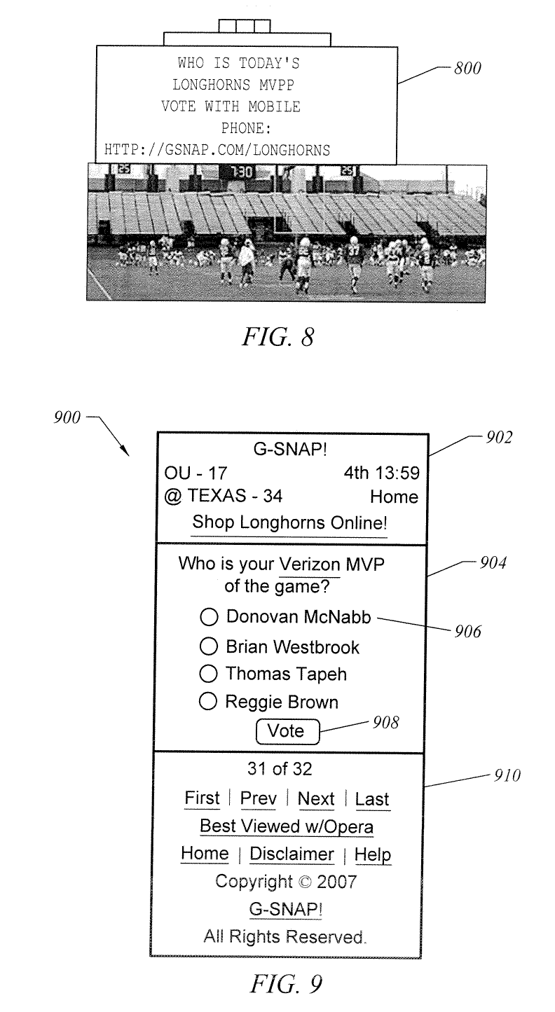

FIG. 8 illustrates a technique for soliciting information for a poll. In this example, the information is solicited on a scoreboard 800 accessible to a set of users. It is possible that a poll can be presented separately from an event broadcast, as shown in connection with FIGS. 8 and 9.

FIG. 9 illustrates a request for poll information displayed on a mobile device. GUI 900 specifies an event in block 902. Block 904 includes a question and radio buttons 906 to enter a vote, which may be submitted with vote button 908.

An embodiment of the invention allows event updates from multiple events to be displayed on a single GUI. Each event has a unique identifier. A request is made to a server containing all the unique identifiers. A response is received with the specific data associated with each unique identifier. The event information can be presented in various ways, such as on a web browser, a mobile browser, a GPS receiver, a television, a desktop application, a desktop widget, a mobile widget, a scoreboard, etc.

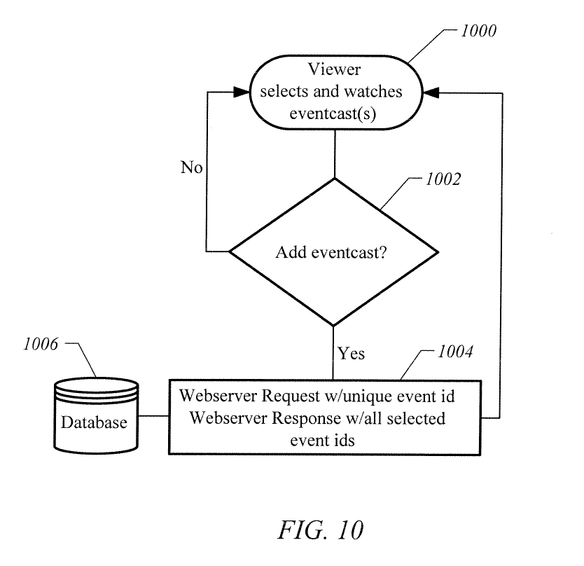

FIG. 10 illustrates processing associated with this embodiment of the invention. Initially, a viewer selects and watches an event 1000. The viewer may request to add an event 1002. If the viewer requests to add an event, the unique event identification is routed to the web server, which responds with information for all of the selected events 1004. The web server may access database 1006 to implement this operation.

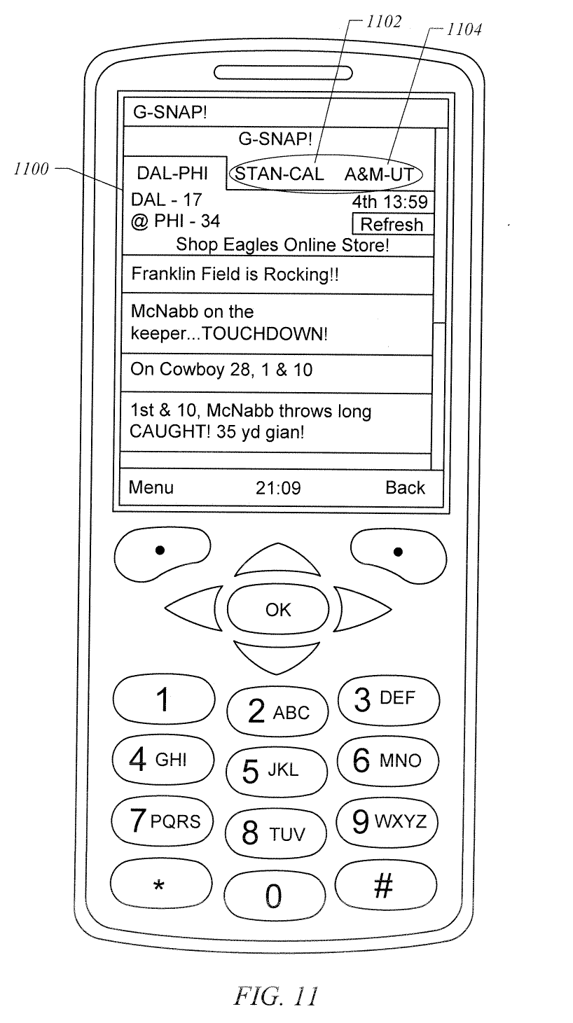

FIG. 11 illustrates a GUI 1100 with information regarding one event. Tabs 1102 and 1104 provide information regarding second and third events, respectively. By clicking on a tab, the information for the selected event appears.

An embodiment of the invention allows for the creation of common and customized shorthand text for fast and convenient data entry on a GUI. For example, a data structure is served up from the form module 146. The data structure contains common shorthand text used to represent longer words or phrases that cannot be input into a form quickly and conveniently. If a user chooses to create customized shorthand, a form is served up to facilitate the expression of customized shorthand. The client event update module 122 parses the structure and detects if the shorthand representation exists. For example, hitting the space bar may trigger this check. If a shorthand equivalent exists, the longer word or phrase is swapped in place of the shorthand expression. If it does not exist, the client event update module 122 assumes that it is a real word and does not perform an operation upon it. Examples of shortcuts of this type are shown in FIG. 5.

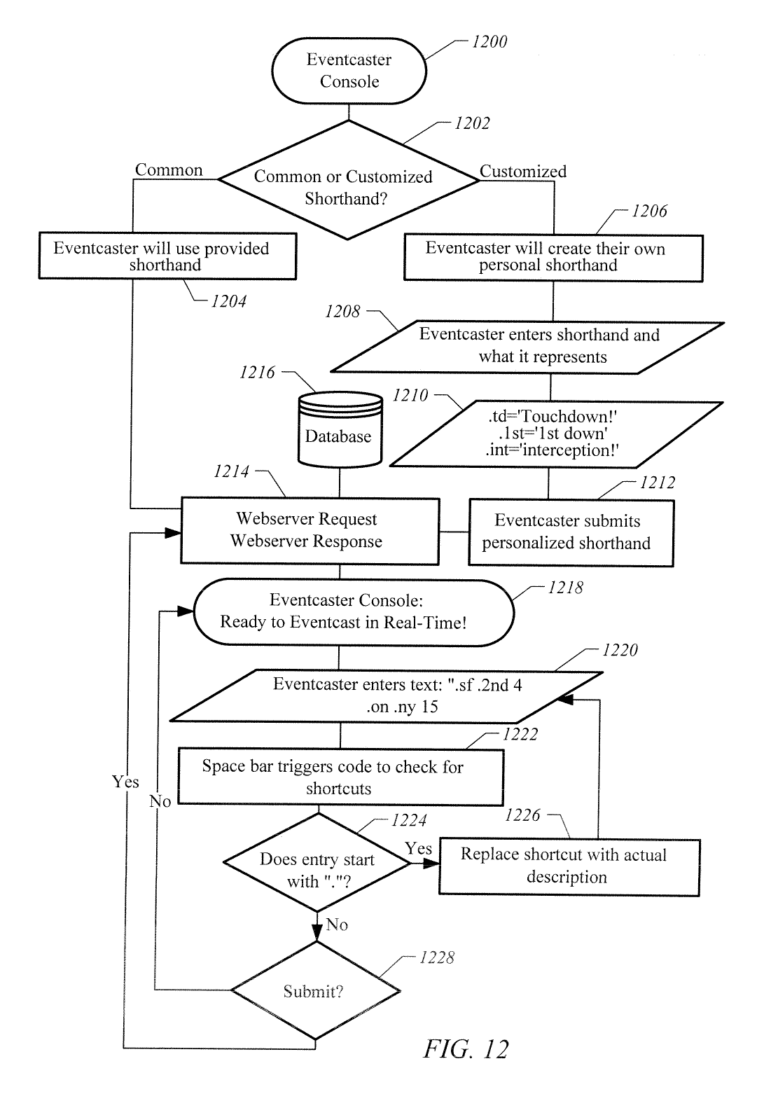

FIG. 12 illustrates processing operations associated with this embodiment of the invention. Processing commences at the console of an individual providing updates on an event 1200. The client event update module 122 queries for common or customized shorthand 1202. If common shorthand is specified, then the client event update module 122 uses a form with supplied shorthand 1204. If custom short hand is specified, the client event update module 122 allows the expression of personalized shorthand 1206. In particular, the user enters shorthand and what it represents 1208. In this example, “.td” is equivalent to “touchdown”, “.1^{st}” is equivalent to “1^{st} down” and “.int” is equivalent to “interception” 1210. The user then submits the personalized shorthand 1212. The web server then processes requests and supplies responses 1214 accessing the database 1216. Once a user is ready to supply a real time update 1218, the user enters shorthand 1220. Activating a key (e.g., the space bar) results in a comparison with shorthand expressions 1222. An expression beginning with a period (“.”) indicates a shortcut 1224. The shortcut is then replaced with the actual description 1226. This replacement may be completed by the client or server. If the text does not invoke a shortcut (1224—NO), the system waits for the submit button 1228. Once the submit button is pressed (1228—YES), the web server processes the information.

In a related embodiment, the form module 146 serves common or customized meta names for buttons or icons to represent longer words or phrases that cannot be input into a form quickly and conveniently. The client event update module 122 displays the button shortcut. When the button is clicked, the longer word or phrase is automatically placed in the form. Once submitted, the event update is written to a database and is subsequently broadcasted to users. This approach may also be used in connection with a GUI on a mobile device, for example, as shown in FIG. 6.

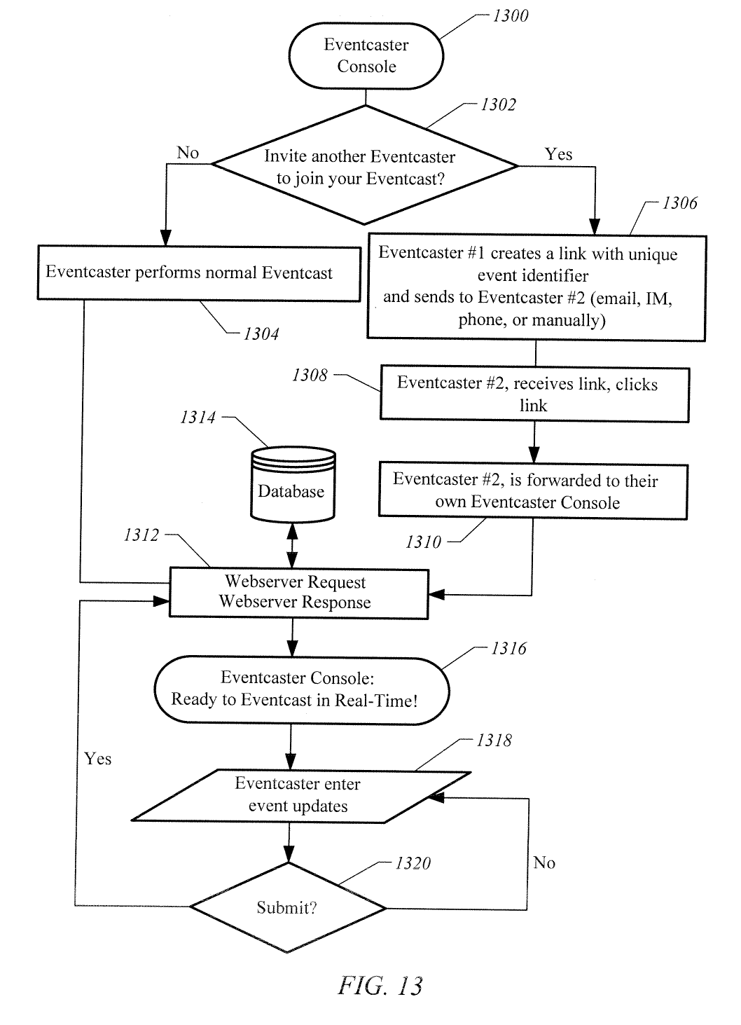

The invention may be implemented to support input to a single event from multiple event broadcasters. Consider the processing of FIG. 13. Processing begins at a console 1300. The client event update module 122 inquiries whether to invite another to provide updates on an event 1302. If the invitation is declined, updates are provided by a single user 1304. If another user is to be invited, the user supplies the invitee with the event identification 1306. The invitee receives the event identification 1308. For example, the invitee may receive a link and then click on the link. The invitee is then supplied with a console of the type disclosed above to report on the event 1310. The web server then processes requests and responses 1312 accessing a database 1314. In particular, at this point, an event can be updated in real time 1316. Each user then updates events 1318. Event updates are then submitted 1320. FIG. 3, panel 302 provides an example of two individuals “txex” 310 and “txam1” 312 providing updates on an event.

The notification module 148 alerts viewers that an event is starting. For example, a Uniform Resource Locator (URL) with a unique identifier specifies where information on a specific event can be viewed. Various techniques may be used to alert potential viewers. For example, a viewer can subscribe to a set of events and then be alerted when a specified event commences. Viewers can subscribe to a favorite team, club, league, organization, event broadcaster or other entity. An event updater can manually or automatically send a broadcast SMS message, instant message, voicemail or email alerting potential viewers about the beginning of an event or event broadcast and a specified URL to receive information about the event.

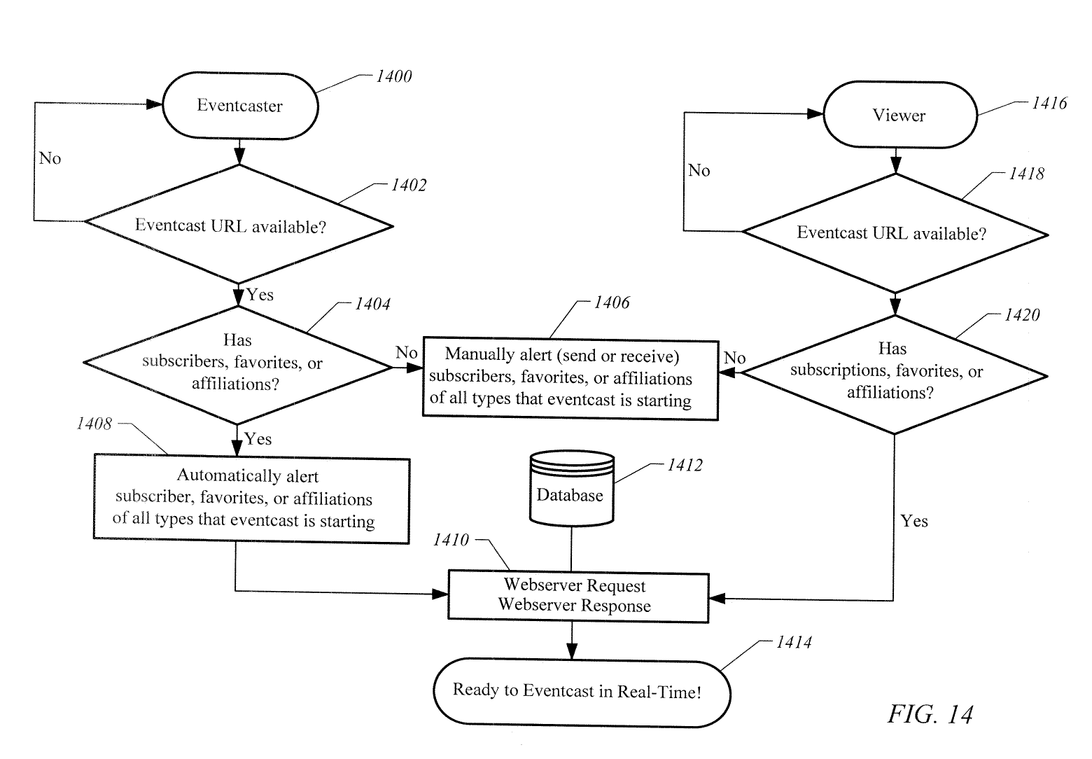

FIG. 14 illustrates notification operations associated with an embodiment of the invention. An individual providing event updates (i.e., an “eventcaster”) may specify a URL for the event 1400. Once a URL is available (1402—YES), it is determined whether there are subscribers, favorites or affiliations that should be notified 1404. If not, a manual alert may be used 1406. If there are entities that should be notified, they are automatically notified 1408. For example, the web server may be used to send alerts 1410 by accessing a list of subscribers in database 1412. Afterwards, the event may be detailed in real-time 1414. A viewer 1416 waits for an event URL 1418. Once it is available, it is accessed.

A rating module 150 may be used to rate the quality of an event. In one embodiment, an individual characterizing an event rates the quality of the event. If multiple individuals are characterizing the event, their ratings may also be considered. The rating module 150 collects event identifiers and scores to produce various types of feedback, such as average score, comparative score to similar events, comparative score to simultaneous events, etc.

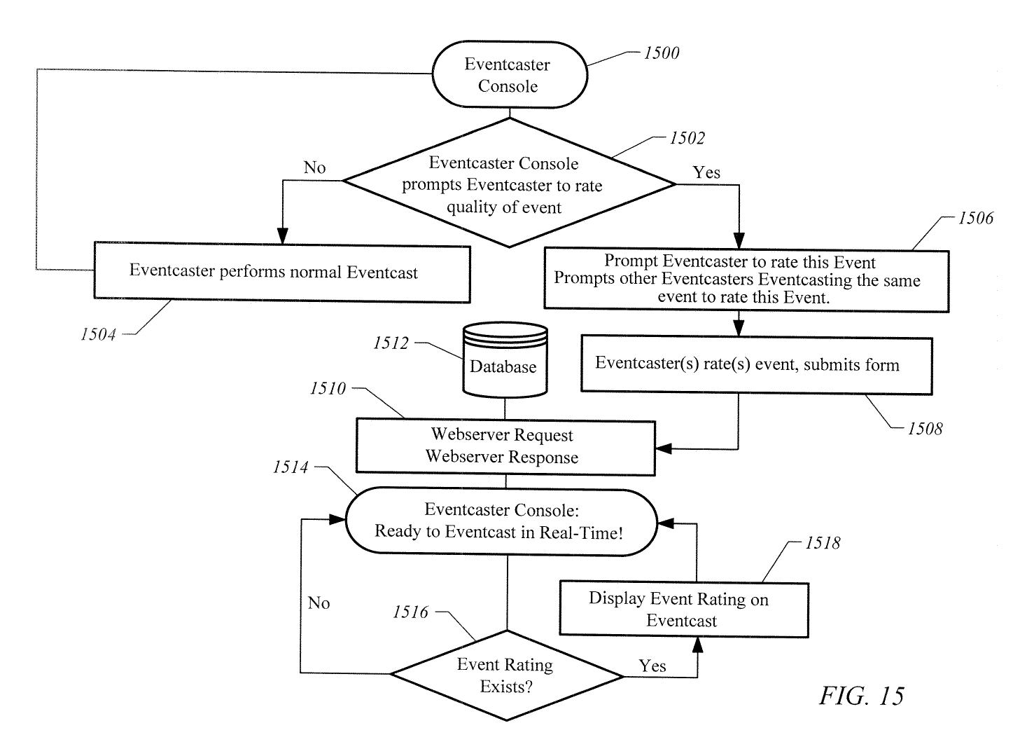

FIG. 15 illustrates rating operations that may be performed in accordance with an embodiment of the invention. A user accesses a console 1500. The user is prompted to rate an event 1502. If the user declines (1502—NO), a normal event transpires 1504. If the user accepts (1502—YES), the user is prompted to rate an event 1506. The user rates an event and submits a form 1508. The form is processed by the web server 1510, which may store rating information in database 1512. When updating an event in real-time 1514, it is determined whether a rating exists 1516. If a rating exists, the rating is displayed 1518. Recall that FIG. 8 displays a scoreboard 800 to solicit rating information. FIG. 9 illustrates a mobile GUI 900 to receive rating information. FIG. 3 also illustrates examples of requests for rating information.

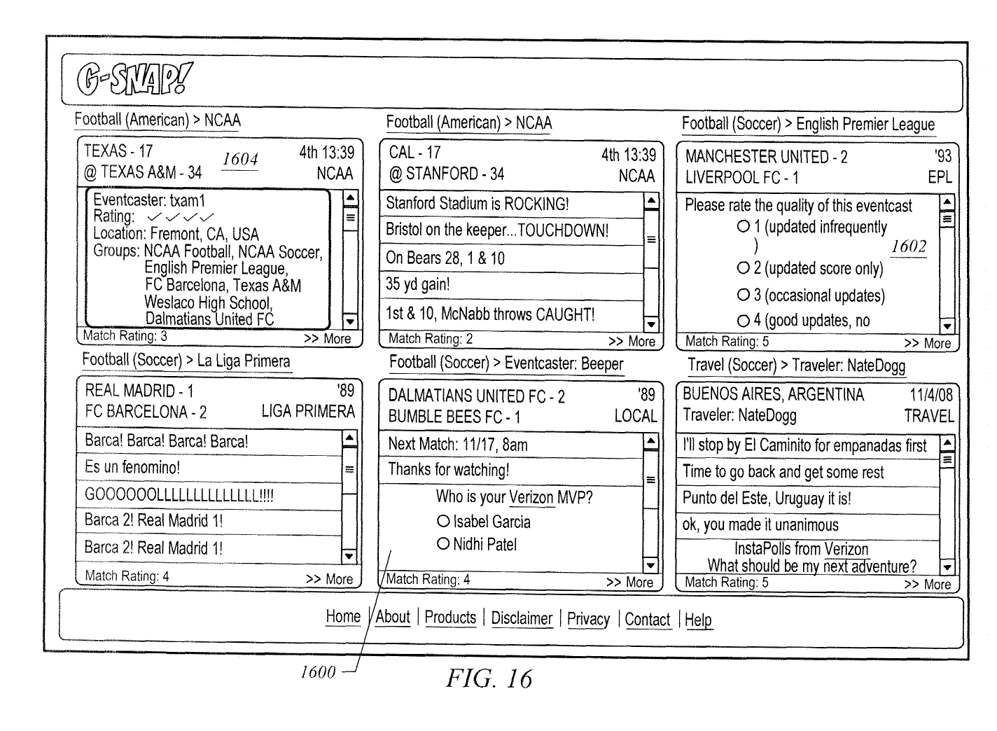

FIG. 16 also provides examples of requests for rating information. Panel 1600 illustrates a request for rating information regarding players in a match. Panel 1602 solicits information on the quality of the event updates or the eventcast. The rating module 150 may also be configured to provide feedback on the individual providing event updates, as shown in panel 1604. In this example, the individual is identified as “txam1”. The individual is assigned a rating. The individual's location and associated groups are also identified.

An aspect of the invention relates to insuring that a viewer receives the most recent update available. This may be done by specifying a manual “refresh” or “update” operation with a cache-breaking link. That is, in accordance with the invention, a refresh or update link is added to a mobile web page to allow a user to conveniently refresh a page. The URL value associated with a request contains a unique identifier in the query string for every request to insure that the user does not receive a cached page. This query string can contain a randomly generated number or a number representing the number of milliseconds since the Unix Epoch (Jan. 1, 1970 00:00:00 GMT). The following code:

<a href=”/samepage.html?cachebreaker=<?php echo
random_number_generator( ); ?>”>Refresh</a>

produces a cache break value of:

<a href=”/samepage.html?cachebreaker=347814946”>Refresh</a> OR
<a href=”/samepage.html?cachebreaker=347814946”>Update</a>

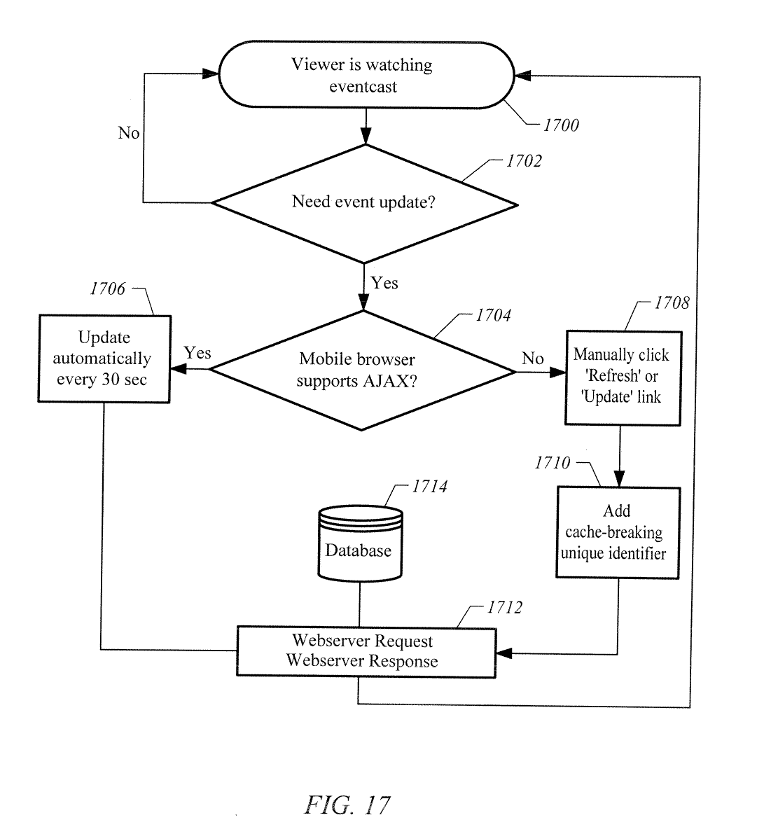

FIG. 17 illustrates update operations performed in accordance with an embodiment of the invention. These operations may be coordinated by the update module 152. Initially, a viewer is watching an event 1700. If an update is needed (1702—YES), it is determined whether the mobile browser supports Asynchronous JavaScript and XML (AJAX). If AJAX is supported (1704—YES), the browser is updated automatically every user configured amount (e.g., 15 seconds) 1706. If AJAX is not supported (1704—NO), the user manually clicks a refresh or update link 1708. The cache-breaking unique identifier is then added 1710. In other words, a unique identifier is created and added to the URL of a request for every refresh or update request to insure that the user never receives a cached mobile page. The web server 1712 may then process requests and responses with access to database 1714.

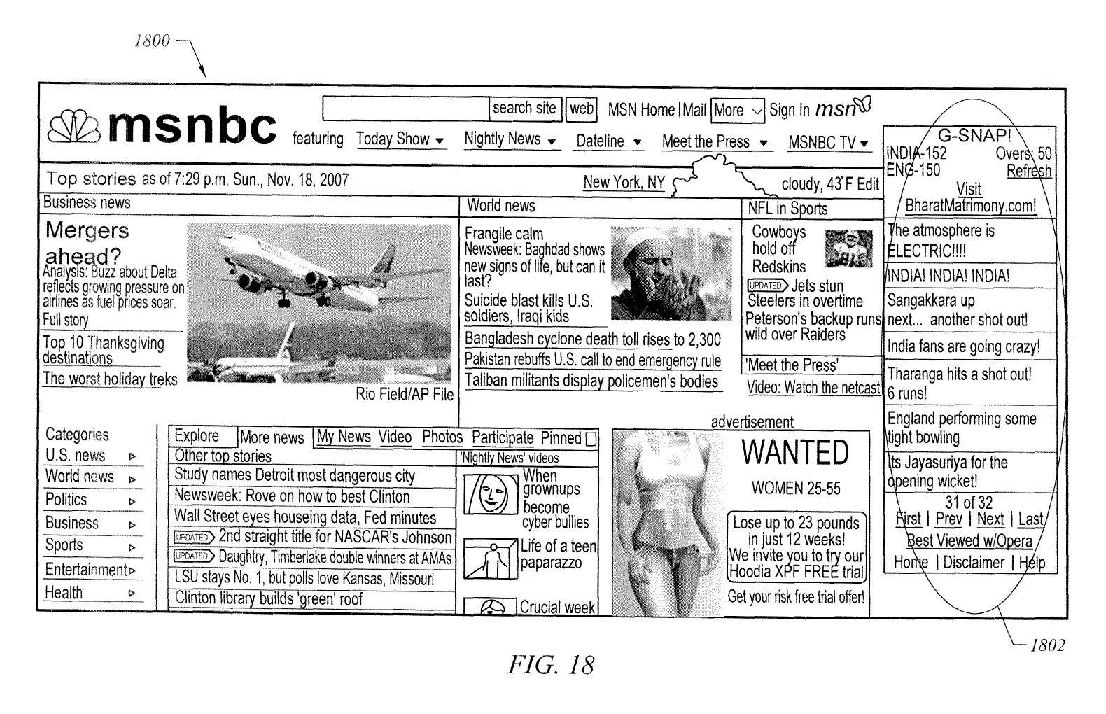

Another aspect of the invention is to allow the viewing of an event from any web page by clicking on a bookmark or browser extension. In a regular view, a link is available that represents the bookmark or browser extension. A viewer converts this link into a bookmark or browser extension via browser menu options. Once this is loaded into the browser, a viewer can select the bookmark or browser extension to enable a new, small, layered popup window to appear on the page. FIG. 18 illustrates a GUI 1800 with an event update panel 1802.

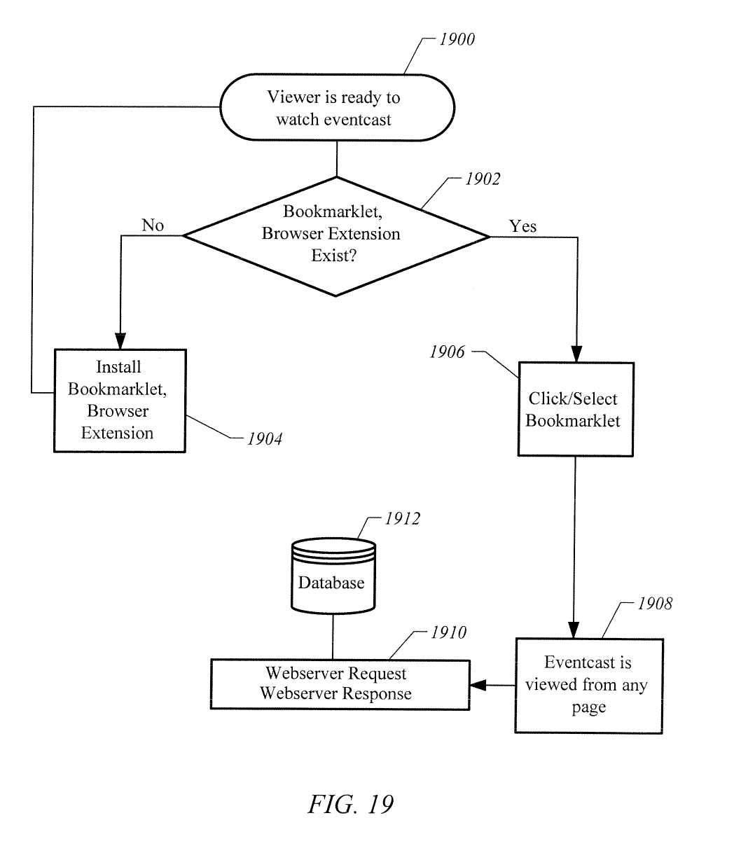

FIG. 19 illustrates processing operations to support such a panel. Initially, a viewer is ready to watch event updates 1900. It is then determined whether a bookmark browser extension exists 1902. If not, the bookmark browser extension is installed 1904. For example, the update module 152 may install the bookmark or browser extension to the client event update module 122. If the bookmark or browser extension is available, it is selected 1906. The event may then be viewed from any web page 1908, as shown in FIG. 18. The web server processes requests and responses 1910 accessing database 1912.

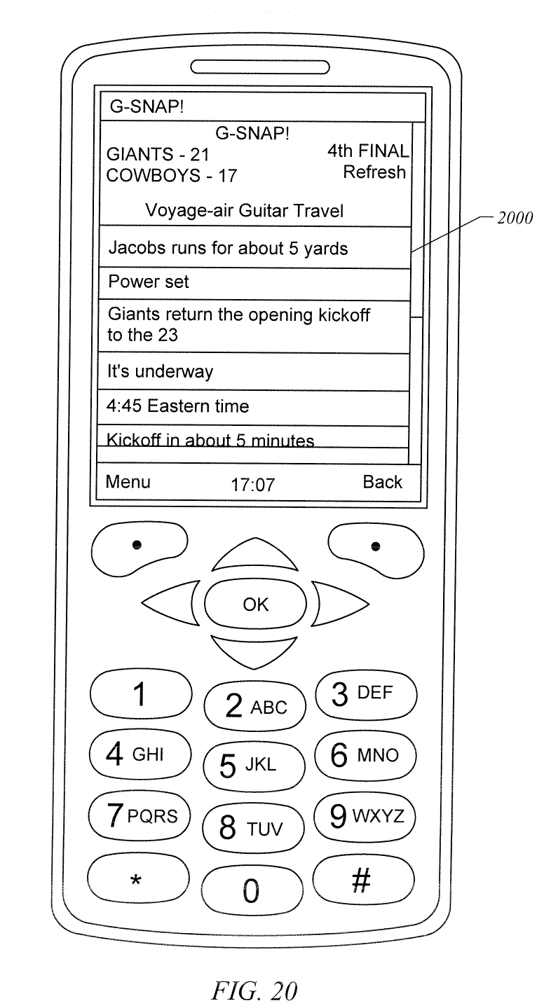

The lighting module 154 may be used to support dark mode operation of a mobile device. A mobile device in a dark room (e.g., a movie theater) may appear as a flashlight with a light colored background and dark colored text. In accordance with an embodiment of the invention, a user can opt to go into a mode where the page is more dark room friendly. When this option is selected, the default or user selected theme is overridden by a dark colored background with light colored text. When the user chooses to do so, the user may return to the default or user selected theme. FIG. 20 illustrates a mobile device with a dark mode GUI 2000 utilized in accordance with an embodiment of the invention. The lighting module 154 may include instructions to toggle the dark mode operation. Alternately the lighting module 154 may include downloadable instructions that are then executed by the client event update module 122.

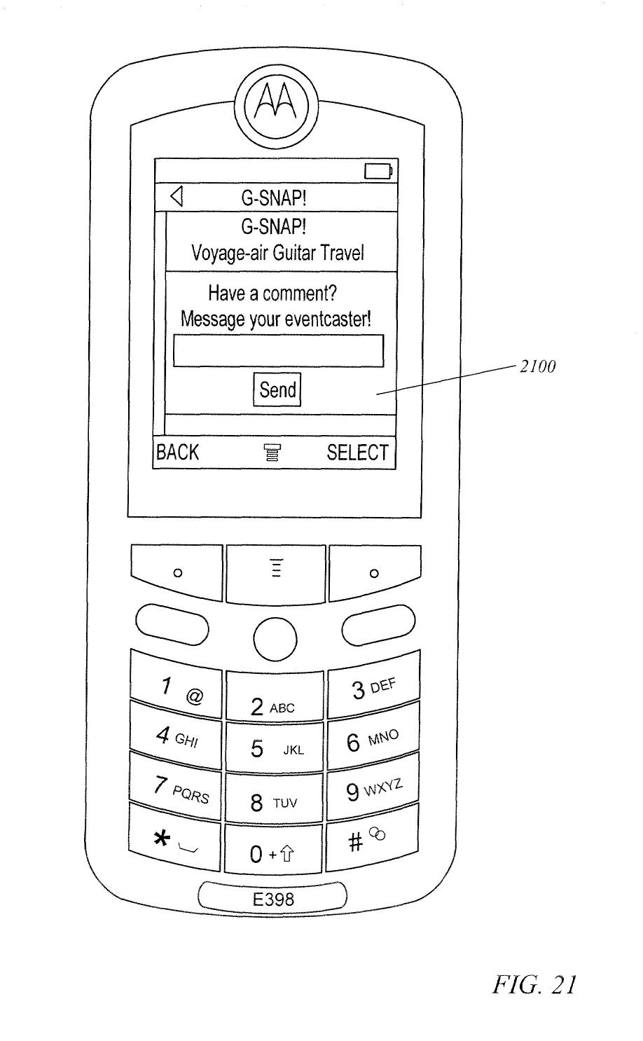

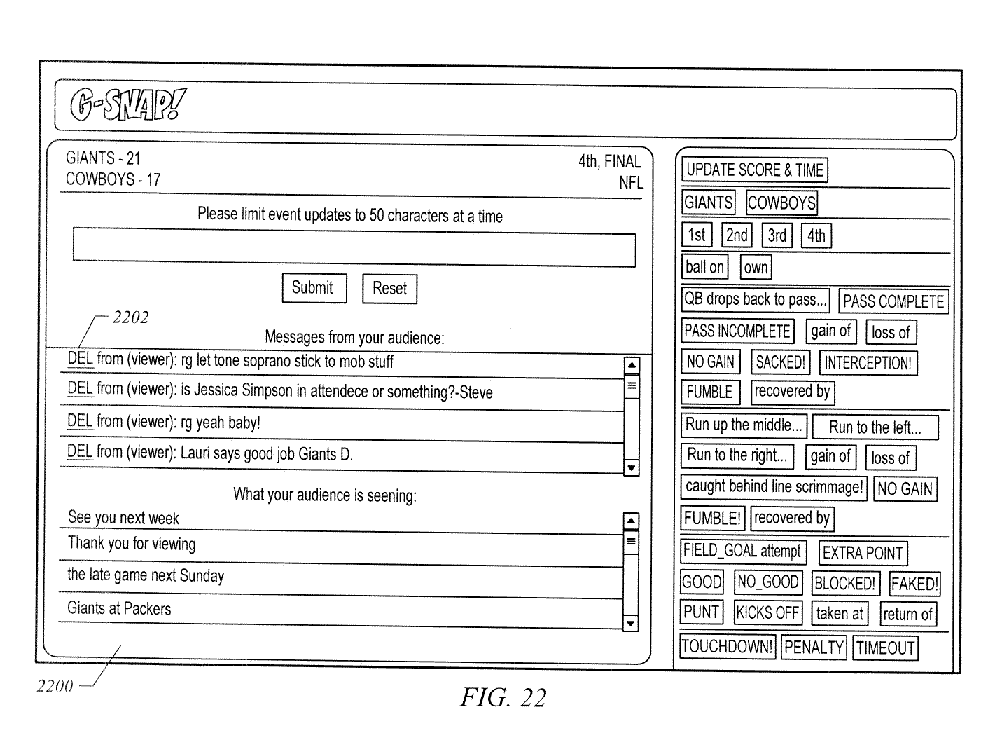

The invention may also be implemented with a content control module 156. In one embodiment, the content control module 156 includes executable instructions to support communications with an eventcaster and allows the eventcaster to decide whether to share those communications as part of a broadcast. FIG. 21 illustrates a mobile device with a GUI 2100 to support communication with a host providing event updates. This GUI may be supplied from the content control module 156 or it may form a part of the client event update module 122. FIG. 22 illustrates a GUI 2200 that lists messages received from an audience. The GUI 2200 allows for the hiding or showing of messages with a “hide” or “show” command 2202. The GUI 2200 also illustrates what comments the audience is allowed to see.

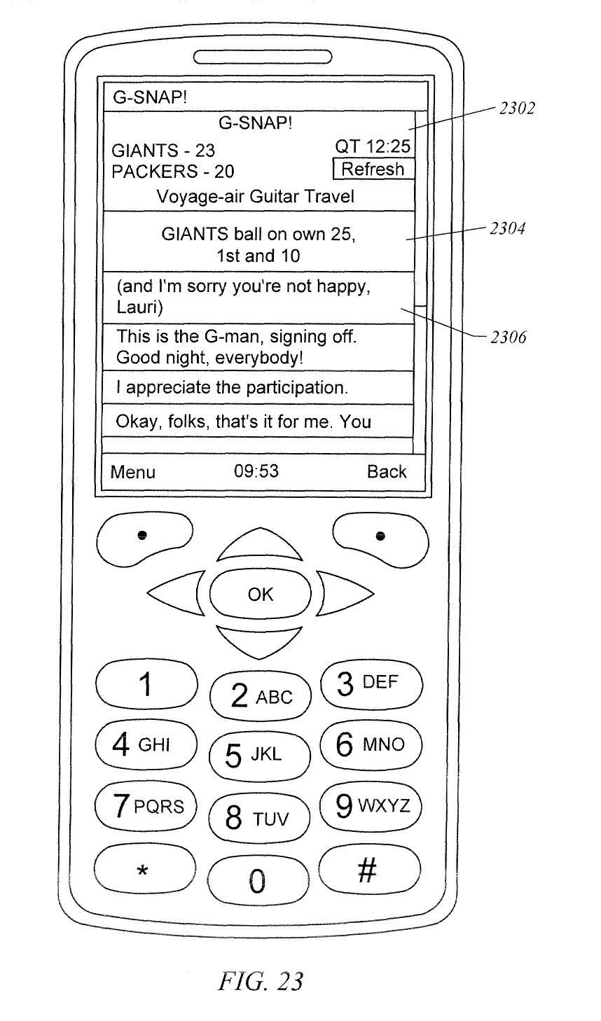

The content control module 156 may also include executable instructions to control the type and amount of data displayed on a mobile device. For example, the user may select event status (e.g., score, time remaining), action status (e.g., team possession, field location) and update status (e.g., event cast play-by-play). FIG. 23 illustrates a GUI 2300 with an event status section 2302, an action status section 2304 and an update status section 2306.

The invention may be implemented in various alternative forms. For example, voice commands may be used instead of the disclosed keystroke commands.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
collect information from a community of event updaters regarding an ongoing event; and
send the information to a recipient community of users that has requested ongoing event updates.

2. The computer readable storage medium of claim 1 wherein the ongoing event is selected from a sporting event, a concert, a conference, a reunion, a political event, and a health care emergency.

3. The computer readable storage medium of claim 1 further comprising executable instructions to gather poll data regarding the ongoing event.

4. The computer readable storage medium of claim 1 wherein the executable instructions to collect include executable instructions to collect information from a web form.

5. The computer readable storage medium of claim 1 wherein the executable instructions to collect include executable instructions to collect information from a web form with data entry shortcuts.

6. The computer readable storage medium of claim 1 further comprising executable instructions to generate an alert to the recipient community of users indicating the commencement of the ongoing event.

7. The computer readable storage medium of claim 1 further comprising executable instructions to process ongoing event rating information received from the recipient community of users.

8. The computer readable storage medium of claim 7 wherein the event rating information characterizes the rating of the event.

9. The computer readable storage medium of claim 7 wherein the event rating information characterizes the rating of individuals providing event updates.

10. The computer readable storage medium of claim 1 further comprising executable instructions to automatically facilitate the receipt of event updates.

11. The computer readable storage medium of claim 10 wherein the executable instructions to automatically facilitate the receipt of event updates include executable instructions to supply a unique identifier with each Uniform Resource Locator (URL) to obstruct cache operations.

12. The computer readable storage medium of claim 1 further comprising executable instructions to display the information on a mobile device.

13. The computer readable storage medium of claim 1 further comprising executable instructions to display the information in combination with distinct web page information.

14. The computer readable storage medium of claim 1 further comprising executable instructions to facilitate the display of the information with a black background.

15. The computer readable storage medium of claim 1 wherein the executable instructions to collect information include executable instructions to collect information from a primary host with control of the distribution of information.

16. The computer readable storage medium of claim 1 further comprising executable instructions to segregate the display of the information on a user device.

17. The computer readable storage medium of claim 1 wherein the executable instructions to send the information to the recipient community of users includes executable instructions to send the information via the Internet.
